(19) United States
(12) Patent Application Publication
(10) Pub. No.: US 2003/0119589 A1
(43) Pub. Date: Jun. 26, 2003

(54) Composite linkshaft bracket

(76) Inventors: Carsten Behrensmeier, Cologne (DE); Holm Schmitt, Koeln (DE)

Correspondence Address: Steven W. Hays, Suite 250, 28333 Telegraph Road, Southfield, MI, 48034, US

(21) Appl. No.: 10/028,834

(22) Filed: Dec. 20, 2001

(51) Int. Cl. F16C 1/26; F16D 3/84

(52) U.S. Cl. 464/178

(57) ABSTRACT

A composite linkshaft bracket having a composite upper portion and a lower portion used to support a bearing supported linkshaft in a vehicle driveline replaces known cast iron brackets. The composite upper portion is formed of a polymer material that is designed for sufficiently high eigenfrequencies due to a low specific weight and high stiffness and the ability to withstand heat distortion temperatures of at least 180 degrees Celsius. Preferably, the polymer material is reinforced with fibrous material such as glass fiber. The lower portion is preferably formed from the same polymer material used in the composite upper portion, however may alternatively be formed of stamped metal.

### TECHNICAL FIELD

The present invention relates generally to linkshaft brackets and more particularly to composite linkshaft brackets.

### BACKGROUND

In vehicles with transversally mounted engines, the differential transmission is typically placed eccentrically relative to the vehicle centerline. In order to maintain equal shaft lengths and joint angles for the right- and left-hand side, which are required for responsive and neutral handling, a linkshaft is required. The linkshaft needs to be supported by a bearing, which itself is supported by a bracket that is mounted on the engine block or ladderframe.

The bracket, typically referred to as a linkshaft bracket, is required to be able to carry the loads introduced by the linkshaft. These loads include the weight of the driveline plus any dynamic forces produced by the inboard and outboard joints. Even more critical than this basic function is the transfer behavior of the linkshaft bracket concerning vibrations coming from the engine that are being transferred through the driveline and into the body structure of the vehicle, which are being experienced by the driver as undesired noise. Vehicle measurements and CAE investigations have shown that in order to eliminate noise as much as possible, the eigenfrequency of the linkshaft bracket needs to be significantly above the second engine order.

Known linkshaft brackets successfully act to reduce vehicle vibrations, but have a number of known shortcomings. For example, because they are typically made of cast iron, they have high specific weight and low strength. Also, cast iron linkshaft brackets require extensive machining and are expensive.

Recently, investigations have been made into other materials to be used in linkshaft brackets. One such material being investigated is plastic. These materials show great potential, but until now have not been incorporated due to material related problems such as unknown thermal behavior, loading conditions, and proper manufacturing techniques. Accordingly, it would be desirable to provide a linkshaft bracket that reduces powertrain vibration and noise and also reduces weight while increasing strength.

### SUMMARY OF THE INVENTION

It is thus an object of the present invention to provide a linkshaft bracket that reduces powertrain vibration and noise while reducing weight and increasing strength.

The above object is accomplished by providing a composite linkshaft bracket for use in a powertrain, or driveline system. The composite linkshaft bracket formed of a polymer material that is designed for sufficiently high eigenfrequencies due to a low specific weight and high stiffness. Preferably, the polymer material is reinforced with fibrous material such as glass fiber.

Other objects and advantages of the present invention will become apparent upon considering the following detailed description and appended claims, and upon reference to the accompanying drawings.

### BRIEF DESCRIPTION OF THE DRAWINGS

FIG. 1 is a perspective view of a vehicle having a driveline according to a preferred embodiment of the present invention;

FIG. 2 is a perspective view of a vehicle driveline according to one preferred embodiment of the present invention;

FIG. 3 is a close-up view of the linkshaft bracket coupling region of FIG. 2;

FIG. 4 is a perspective view of a lower portion of the linkshaft bracket; and

FIG. 5 is a perspective view of the linkshaft bracket.

### DESCRIPTION OF THE PREFERRED EMBODIMENT(S)

In the following figures, the same reference numerals will be used to identify identical components in the various views. The present invention is illustrated with respect to a steering system, particularly suited for the automotive field. However, the present invention is applicable to various other uses that may require driveline systems.

FIG. 1 illustrates a vehicle 8 having a powertrain, or driveline 10, according to one preferred embodiment of the present invention.

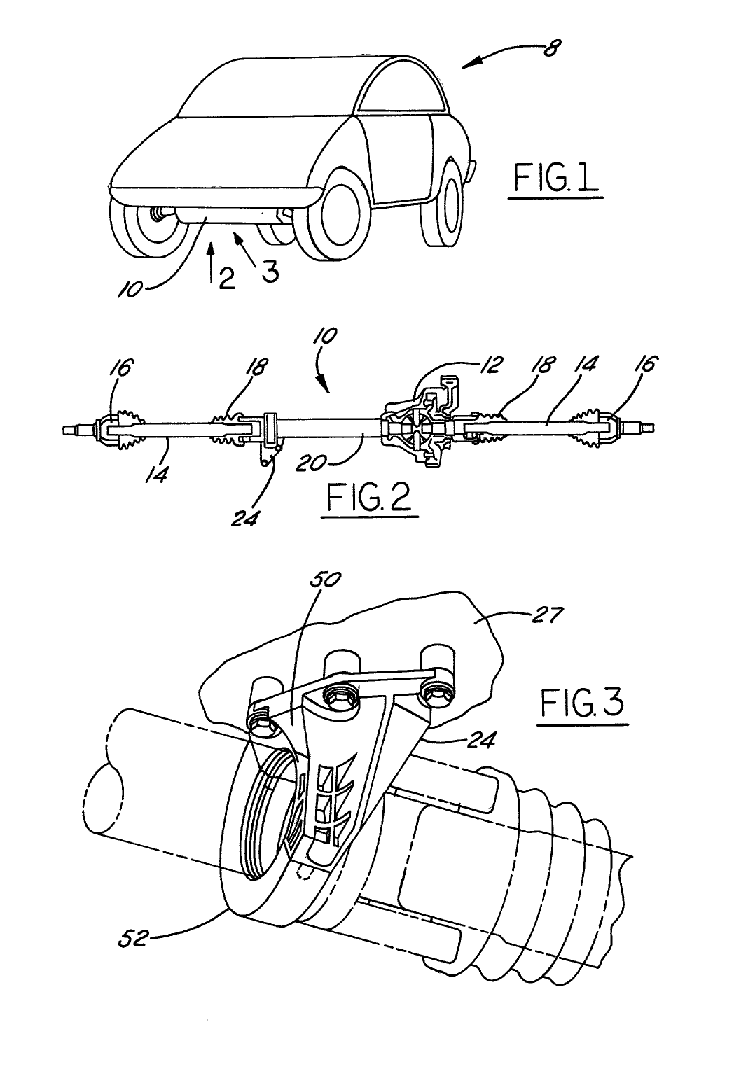

Referring now to FIGS. 2 and 3, the driveline 10 consists of a differential transmission 12 that is placed eccentrically relative to the vehicle 8 centerline. One of a pair of interconnecting shafts 14 is coupled between an outboard joint 16 and an inboard joint 18 on each side of the vehicle centerline in a method well known in the art. In order to maintain equal shaft 14 lengths and joint 16, 18 angles, which are required for responsive and neutral handling, a linkshaft 20 is coupled between the differential 12 and one of the inboard joints 18. The linkshaft 20 is supported by a bearing (shown as 22 in FIG. 6), which itself is supported by a linkshaft bracket 24 that is mounted to the engine block or ladderframe (shown as 27 in FIG. 3).

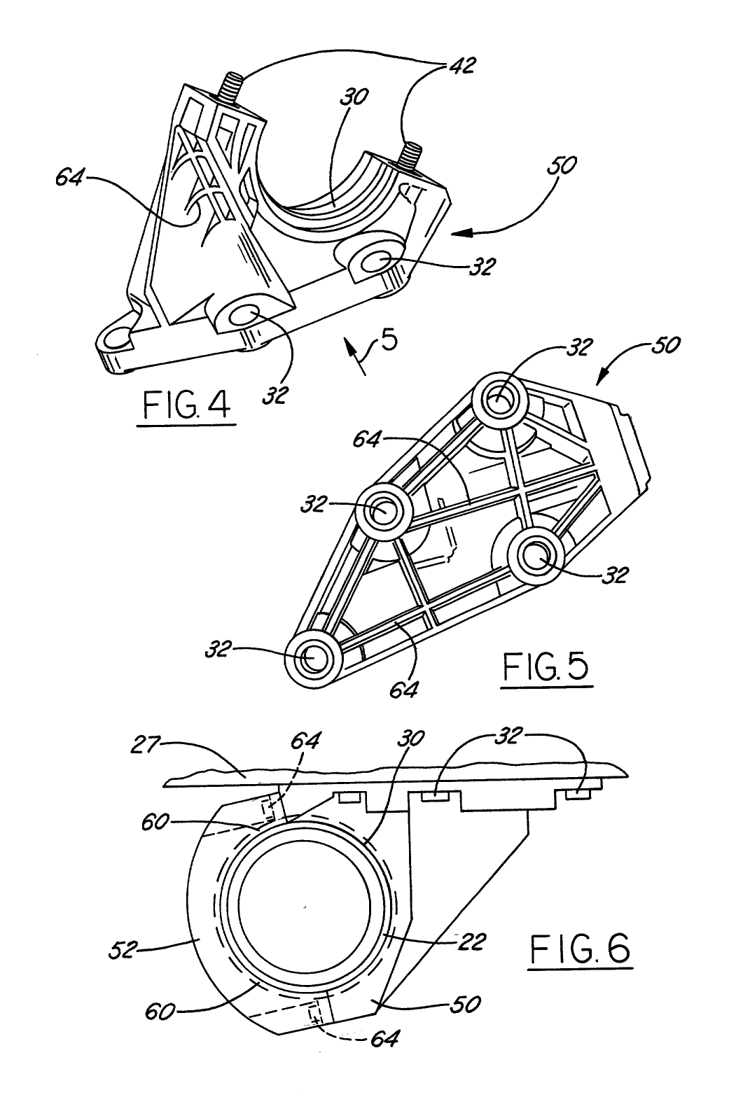

FIGS. 4 and 5 shows a perspective view of the upper portion 50 of the linkshaft bracket 24 of FIGS. 2 and 3 according to a preferred embodiment of the present invention. FIG. 6 illustrates the lower portion 52 of the linkshaft bracket 24 coupled to the upper portion 50 and surrounding the bearings 22 and linkshaft 20 of FIGS. 2 and 3.

Referring now to FIGS. 4 and 5, an upper portion 50 of the linkshaft bracket 24 is shown having a spherical region 30 that supports the bearing 22 and a plurality of mounting holes 32 to mount the linkshaft bracket 24 to the engine block or ladderframe 27. The mounting holes 32 are adapted to receive a fastener, such as a bolt, screw, stud, or similar fastening device. A plurality of raised ribbed regions 64 are preferably added that contribute to the overall strength and stiffness of the upper portion 50. The upper portion 50 also has a pair of mounted studs 42 that couple a corresponding inlet 64 in the lower portion 52.

Referring now to FIG. 6, the lower portion 52 has a spherical region 60 that supports a lower portion of the bearing 22 and also has the aforementioned inlets 64. The inlets 64, while adapted to receive a corresponding stud 42, may be adapted to receive a fastener, such as a bolt, screw, or similar fastening device on the upper portion 50. As is best seen in FIGS. 3 and 6, the spherical regions 30, 60 surround and enclose a portion of the bearing 22 that support the linkshaft 20.

The linkshaft bracket 24 of FIGS. 4-6 is formed of a polymer material that is designed for sufficiently high eigenfrequencies due to a low specific weight and high stiffness. The bracket 24 must be able to withstand heat distortion temperatures of at least 180 degrees Celsius that are commonly experienced in drivelines 10. The bracket 24 is also designed to carry the weight and loads transduced by the driveline 10 systems of the associated vehicle 8.

The bracket 24 may be formed by many processes well known in the art of plastics engineering, including but not limited to injection molding and compression molding. Of course, depending upon the size as well as the vibration and performance characteristics desired for the associated vehicle 8, a large number of design variations and material choices may be utilized to make the composite linkshaft bracket 24.

One preferred material used in the linkshaft bracket 24 of FIGS. 4-6 is a 30% by weight glass reinforced heat resistant aliphatic polyamide formed by the polycondensation of 1,4 diaminobutane and adipic acid. One such reinforced polyamide plastic is Stanyl® (PA46), manufactured by DSM Engineering Plastics. Stanyl® has a high heat distortion temperature of approximately 290 degrees Celsius, ideal for higher temperature applications such as in drivelines. The linkshaft bracket 24 is preferably formed in two pieces by injecting the Stanyl® into an injection mold at between approximately 300 and 325 degrees Celsius at an input pressure of approximately 700-1100 bars. The mold temperatures are maintained between approximately 60 and 120 degrees Celsius with a residence time of less than approximately 6 minutes. The finished upper portion 50 and lower portion 52 of linkshaft bracket 24 is then ejected and cooled. Studs 42 may be added in a post-processing step or may be surrounded with the plastic material in the mold.

The Stanyl® linkshaft bracket 24 with 30% glass fiber reinforcement allows for maximum stresses of 21 MPA and a maximum displacement of approximately 0.9 mm with a temperature resistance of up to 220 degrees Celsius. Further, modal analysis reveals natural frequencies of a minimum of 1080 Hertz in first mode.

One preferred example of settings using a high flow version of Stanyl® (46HF5040) using an injection molding machine with a 22 mm screw diameter has a temperature profile from hopper to nozzle: 290-295-305-315-315-315 degrees Celsius (or 325-330 degrees Celsius in the compression/metering zone) with a back pressure of 25 bar specific, a rotation speed of 340 rpm, an injection speed of a maximum of 100 mm/sec, and a holding pressure of less than 350 bars specific. The mold temperatures are maintained between approximately 80 and 120 degrees Celsius.

The composite linkshaft bracket 24 of the present invention offers many advantages over known cast iron linkshaft brackets. The bracket 24 reduces powertrain vibration and noise. The bracket 24 also reduces weight that can lead to increased fuel economy. Further, composite linkshaft brackets do not require extensive machining as do known cast iron linkshaft brackets, and thus manufacturing cost savings are realized. Finally, depending upon vehicle 8 size and performance characteristics desired, material choice and/or processing of the upper and lower portions 50, 52 may be altered in order to achieve a desired result. For example, the amount or type of fiber reinforcement, polymer choice, or number of mounting structures may be altered as is well known in the art to increase bracket strength or increase bracket heat distortion.

While the invention has been described in terms of preferred embodiments, it will be understood, of course, that the invention is not limited thereto since modifications may be made by those skilled in the art, particularly in light of the foregoing teachings. For example, the lower portion 52 of the linkshaft bracket 24 could alternatively be formed from sheet metal stamped to its preferred shape and coupled with the upper portion 50. This would impart some manufacturing cost savings potentially against the expense of some driveline vibration and noise.

What is claimed is:

1. A driveline for a vehicle comprising:
a differential transmission placed eccentrically relative to the vehicle centerline;
a first inboard joint coupled to one side of said differential transmission;
a first interconnecting shaft coupled to said first inboard joint and to a first outboard joint;
a linkshaft coupled to said differential transmission and to a second inboard joint;
a second interconnecting shaft coupled to said second inboard joint and a second outboard joint;
a bearing for supporting said linkshaft; and
a composite linkshaft bracket used to support said bearing.

2. The driveline of claim 1, wherein said composite linkshaft bracket comprises an upper portion and a lower portion, wherein said upper portion and said lower portion, when coupled, surround and support said bearing.

3. The driveline of claim 2, wherein said upper bracket has a plurality of mounting holes, a plurality of raised ribbed regions, a pair of mounted studs, and a spherical region.

4. The driveline of claim 3, wherein said upper portion of said composite linkshaft bracket is coupled to an engine block or ladderframe of the vehicle through said plurality of mounting holes.

5. The driveline of claim 3, wherein said lower portion has a spherical region and an inlet region corresponding to each of said studs used to couple said lower region to said upper region.

6. The driveline of claim 1, wherein said upper portion of said composite linkshaft bracket is formed of a polymer material that has a heat distortion temperature of greater than 180 degrees Celsius.

7. The driveline of claim 6, wherein said lower portion of said composite linkshaft bracket is formed from a material selected from the group consisting of said polymer material and metal.

8. The driveline of claim 7, wherein said polymer material comprises a fiber reinforced heat resistant aliphatic polyamide.

9. The driveline of claim 7, wherein said polymer material comprises Stanyl® with 30% glass fiber reinforcement.

10. A composite linkshaft bracket used to support a bearing supported linkshaft in a vehicle driveline comprising:
a composite upper portion having a plurality of mounting holes, a pair of mounted studs, and an upper spherical region; and
a lower portion coupled to said upper portion, said lower portion having a lower spherical region and a pair of inlets, wherein each of said pair of inlets couples with a corresponding one of said pair of mounted studs to surround and support the bearing supported linkshaft.

11. The composite linkshaft bracket of claim 10, wherein said composite upper portion is formed of a polymer material that has a heat distortion temperature of greater than 180 degrees Celsius.

12. The composite linkshaft bracket of claim 11, wherein said lower portion of said composite linkshaft bracket is formed from a material selected from the group consisting of said polymer material and metal.

13. The driveline of claim 12, wherein said polymer material comprises a fiber reinforced heat resistant aliphatic polyamide.

14. The driveline of claim 12, wherein said polymer material comprises Stanyl® with 30% glass fiber reinforcement.

15. The driveline of claim 10, said upper composite portion further comprising a plurality of raised ribbed regions used to increase the strength of the upper composite portion.

16. A method for decreasing weight in a transversally mounted driveline comprising:
providing a composite linkshaft bracket having a composite upper portion and a lower portion, said composite upper portion having a heat distortion temperature of at least 180 degrees Celsius;
coupling said composite upper portion to said lower portion of said composite linkshaft bracket such that said composite linkshaft bracket surrounds a bearing used to support a linkshaft in the transversally mounted driveline; and
coupling said composite linkshaft bracket to a vehicle ladderframe or engine block.

17. The method of claim 16, wherein providing a composite linkshaft bracket comprises providing a composite linkshaft bracket having a 30% glass reinforced polyamide composite upper portion and a lower portion, said lower portion selected from the group consisting of a 30% glass reinforced polyamide composite lower portion and a stamped metal lower portion, wherein said 30% glass reinforced polyamide composite upper portion and said lower portion has a heat distortion temperature of at least 180 degrees Celsius.

18. The method of claim 16, wherein coupling said composite upper portion to said lower portion comprises coupling a stud on said composite upper portion within each of a pair of inlets on said lower portion such that said composite linkshaft bracket surrounds a bearing used to support a linkshaft in the transversally mounted driveline.

19. The method of claim 16, wherein coupling said composite linkshaft bracket to a vehicle ladderframe or engine block comprises coupling said composite upper portion of said composite linkshaft bracket to a vehicle ladderframe or engine block through a plurality of mounting holes.
